(19) United States
(12) Patent Application Publication
(10) Pub. No.: US 2013/0180294 A1
(43) Pub. Date: Jul. 18, 2013

(54) Removable Door Locking Mechanism

(71) Applicants: Itzhak Pomerantz, Kefar Sava (IL); Shlomo Caine, Jerusalem (IL); Zuk Turbovich, Lehavim (IL)

(72) Inventors: Itzhak Pomerantz, Kefar Sava (IL); Shlomo Caine, Jerusalem (IL); Zuk Turbovich, Lehavim (IL)

(21) Appl. No.: 13/732,397

(22) Filed: Jan. 1, 2013

Related U.S. Application Data
(60) Provisional application No. 61/584,279, filed on Jan. 8, 2012.
(60) Provisional application No. 61/605,202, filed on Mar. 1, 2012.

(51) Int. Cl. E05C 19/18

(52) U.S. Cl. CPC E05C 19/184
USPC 70/20

(57) ABSTRACT

Disclosed herein is method of locking and unlocking a door that is equipped with an electronic lock, to be locked and unlocked with a removable mechanical lock, enabling orthodox Jews that observe the Sabbath laws to use the door on Saturdays. Also disclosed herein is how to fortify a hotel room door by adding a removable mechanical proprietary lock over the built-in electronic lock. These modifications can be done without damaging the door.

### RELATED APPLICATION

This application claims priority under 35 U.S.C. §119(e) to U.S. Provisional Application No. 61/584,279, filed Jan. 8, 2012, and to U.S. Provisional Application No. 61/605,202, filed Mar. 1, 2012, which are both hereby incorporated by reference in its entirety.

This application claims priority under 35 U.S.C. §119(b) to Israeli Patent Application [not yet available], filed Dec. [approximately the 30^{th}], 2012, which is hereby incorporated by reference in its entirety.

### BACKGROUND

Electronic locks are well known in the art, and are widely used in hotel room doors all over the world.

These locks are opened by a token that delivers a unique identifying signal to the lock. The lock recognizes the token, and enables the opening of the door. The token serves as a key. The most popular type of token is a magnetic card that can be programmed at the hotel reception with the code of the guest's room. A large variety of electronic locks for hotel doors is available from Orbita Technology co., LTD 6th floor, Bldg A3,Xiufeng industrial zone, Buji, Longgang District, Shenzhen, China. All of the electronic locks involve electrical circuitry.

Among the rules of the Jewish religion, that millions of people observe, is a rule that disallows activating an electrical circuit on Saturday. The rules regarding activation of electricity in Saturday is explained in much detail in the following Wikipedia link: http://en.wikipedia.org/wiki/Electricity_on_Shabbat_in_Jewish_law

The result of these two facts is that observant Jewish guests cannot negotiate their hotel room doors on Saturdays.

There are hotels, in places of large Jewish population, where the hotel doors are equipped with both electronic and mechanical locks, and observant Jews on Saturdays disregard the electronic locks and use the mechanical locks. But in the vast majority of hotel rooms there are electronic locks only.

In addition to this, the conventional electronic hotel door locks have been found breakable without leaving a trace as described in the public domain—http://www.pcworld.com/article/259778/50_hacking_device_opens_millions_of_hotel_room_locks.html. While it is likely that lock manufacturers will eventually upgrade the electronic locks to withstand this attack, it will take many years until millions of existing hotel doors will be upgraded. Currently, the electronic hotel room door lock is considered to be less than secure, and there is an un-met need for security minded guests to increase their security and lock the hotel room door positively.

There is a need, that has moral and commercial value, for a system that a guest can bring with them to the hotel, and temporarily retrofit to the door in a non-invasive installation to work with a mechanical lock even in the absence of a built-in mechanical lock.

The following background terms are presented with definitions:
Inwards swinging room door—a door of a room that swings into the room to open
Internal side of a door—the side of the door facing into the room
External side of a door—the side of the door facing out of the room
Invasive installation—an operation of installing a removable device on a door, that leaves marks or damages to the door after removal of the device.
Non-invasive installation—an operation of installing a removable device on a door, that does not leave marks or damages to the door after removal of the device.
Lock face-plate—a metal plate that fixes a door lock to the panel of a door, comprising openings for the latch and the deadbolt of the lock to pass through
Face plate mouth—the opening in the face-plate through which the door latch passes in and out, and the cavity behind it.

### SUMMARY

The invention will be explained using the following terms, description, drawings and description of drawings.

The present invention may be embodied as a system or a method for temporarily adding a removable door lock to an existing room door. The invention teaches a simple method and system that can be used by any hotel guest to add a mechanical lock to the resident magnetic door lock. Common to all embodiments of this invention are—

1. The lock is non-invasive: it is installed on the door and is removed from the door without leaving a mark on the door

2. The lock has at least the following parts:
a. A door mounted member that can be mounted on the internal side of the door and extends to the external side of the door by passing between the door and the door frame or the floor
b. An external member that is mounted outside the room and can grip the first member to a stationary object such as the carpet or the door frame
c. An ordinary mechanical lock, with a physical key or a combination key that prevents—when locked—the separation between the two members. The disclose presents three different embodiments of the lock as examples.

### BRIEF DESCRIPTION OF THE DRAWINGS

FIGS. 1A and 1B show the basic parts of a door used in this specification and serve as a legend of terms;

FIG. 2 shows one embodiment of the lock, where the stationary object is a carpet under the door;

FIG. 3 shows another embodiment of the lock where the stationary object is the door frame and the external member is a bolt perpendicular to the door;

FIG. 4 shows another embodiment of the lock where the stationary object is the door frame, and the external member is a bar leaning on the door and on the door frame;

FIGS. 5A and 5B show another embodiment of the lock where the stationary object is the door frame and the internal object is a strap tied to the inner door handle;

FIG. 6 shows another embodiment of the lock where the stationary object is the door frame and the external member is tied to the intermediate member with a chain;

FIGS. 7A and 7B show an embodiment in which the inner member is installed on a corner of the door;

FIGS. 8A and 8B show an embodiment in which the external member is a bar sliding on a slotted rail and fastened by a wedge; and

FIGS. 9A-9E show components of another embodiment, and FIG. 9F shows how the components are assembled.

### DETAILED DESCRIPTION OF THE DRAWINGS

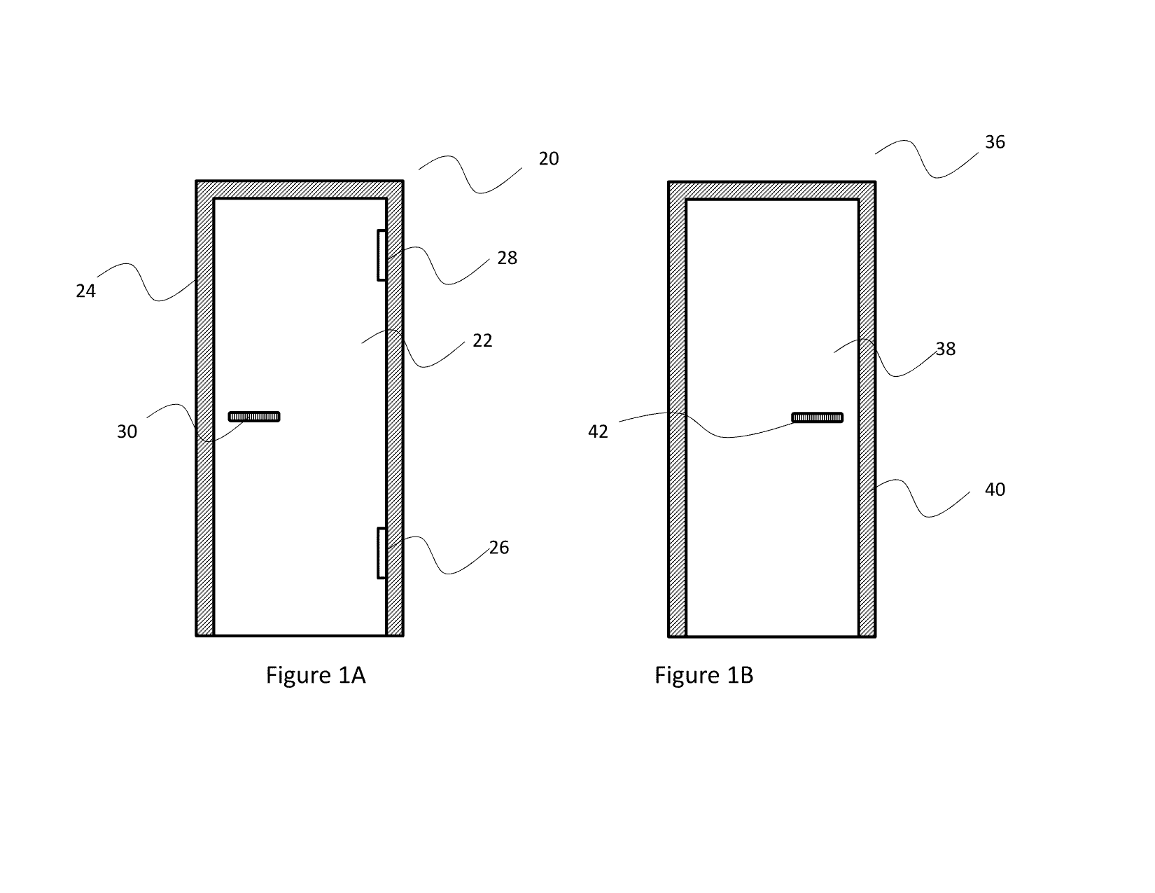

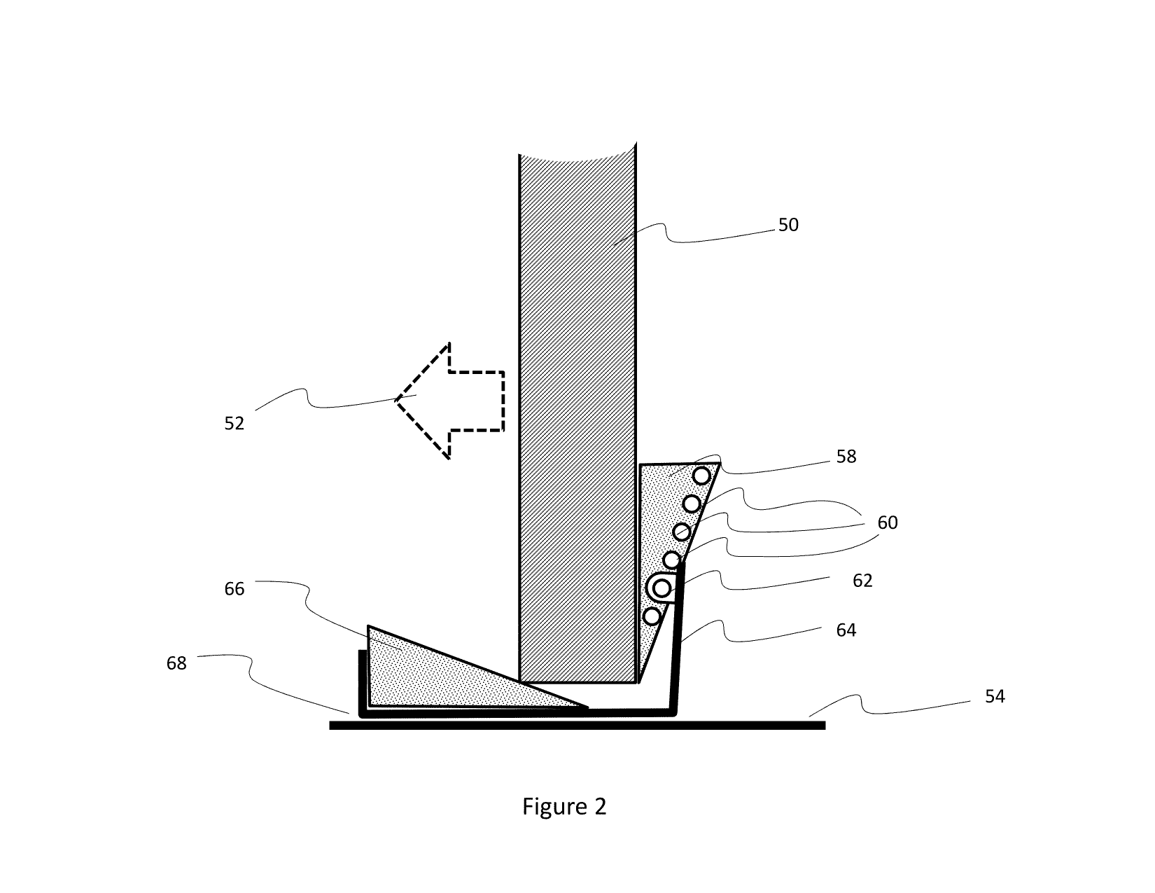

Attention is called to FIG. 1A showing a room door system 20 viewed from the inner side of a room. The door system comprises a door 22, a door frame 24 going around three sides of the door, a door handle 30 and two or more door hinges 28 and 26. These parts will be used in the specification and are mentioned here as a legend.

Attention is called to FIG. 1B showing a door system 36 viewed from outside the room. The door system comprises a door 38, a door frame 40 and a handle 42. As is typical to hotel room doors, the door of these figures swings inwards to the room for opening.

Attention is called to FIG. 2 showing one preferred embodiment of the present invention in a side view, from the direction of the hinges towards the direction of the handle. Only the bottom part of the door is shown.

A metal tray 64 is sled between a door 50 that is designed to open in direction 52, and the floor or a wall-to-wall carpet 54 under the door.

A wedge 66 made of wood, plastic or other solid material is sled between the door 50 and the tray 64 from the inside of the room.

The door is then closed, and the user completes the locking process from the outside of the room.

Another wedge 58 is inserted vertically between the external side of door 50 and the external edge of the tray 64. The vertical wedge is perforated with a series of through holes. The wedge is pushed strongly downward, possible by stepping down on it with a shoe. As the vertical wedge is pushed down, it applies a very strong force on the tray to move outwards under the door. As the tray attempts to move outwards, it pushes the horizontal wedge 66 deeper under the door. As the door cannot raise in its frame, a strong friction is generated between the bottom of the tray 68 and the carpet. The bottom of the tray is preferably roughened and has a very high friction coefficient with the carpet.

The vertical wedge is then locked in its low position with an ordinary padlock (not shown) that is inserted through a horizontal hole 62 in the tray and one of the holes 60 in the wedge, to prevent it from being released upwards.

The strong friction between the tray and the carpet prevents the tray 64, and the door 50 from swinging into the room in the direction 52. The door is also prevented from swinging outwards in the opposite direction by the door frame (not shown). The door is, in this state, locked.

In order to open the door, the padlock has to be opened with its key and removed from the hole 62, the vertical wedge 58 has to be pushed upwards and released from the tray 64, the tray has to be pushed inwards under the door to release the pressure on the horizontal wedge 66, and then the door can be slightly open and the tray can be sled radially along the bottom edge of the door away from the hinges and be released.

If the lock of the present invention is used to avoid the use of the magnetic card or electronic internal lock of the door—that internal lock has to be neutralized. This can be simply done by covering the mouth of the lock panel, on the door frame, with a magnetic plate such as an ordinary refrigerator magnet cut to fit the width of the door frame, or by temporarily filling the mouth of the lock panel with soft material. Methods of neutralizing the internal lock are not a part of the present invention.

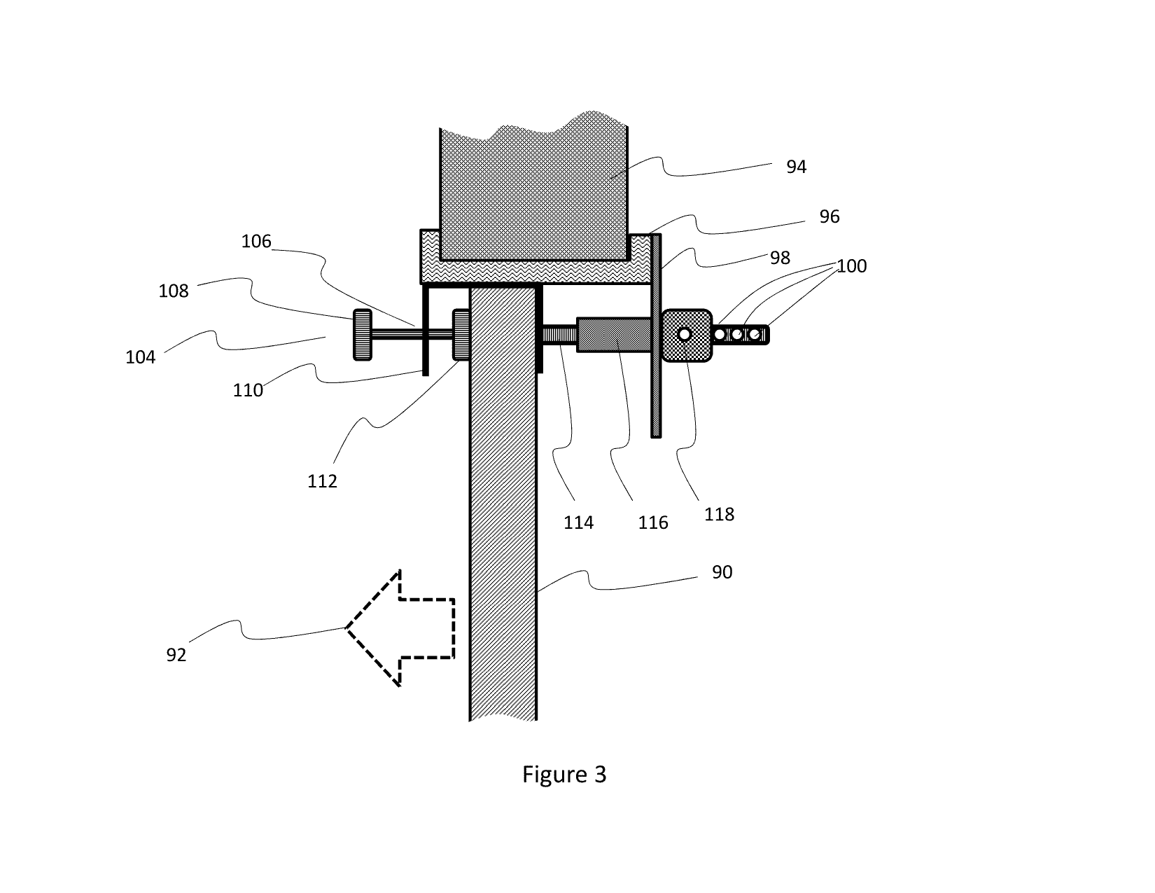

Attention is called to FIG. 3, showing another preferred embodiment of the present invention in a top view of a cross section through the door and the door frame.

A G clamp 110 made of thin metal such as a 1 mm steel plate is clamped to a door 90 that opens in the direction 92. The hinges of the door are not shown as the door extends down to the hinges out of the margin of the figure.

The clamp is clamped to the inside of the door with a mechanism 104, comprising a bolt 106 screwed through a threaded nut on the clamp (not shown), an upholstered foot 112 leaning on the internal side of the door, and a knob 108 used to thread the bolt 106 to tighten foot 112 on the door. The clamp passes between the door 90 and the door frame 96 that is fixed to the wall 94.

A fixed bolt 114 is secured to the clamp on the external side of door 90. The bolt is perforated with a dense series of holes 100. A thumb-tack shaped member that has a tube 116 and a typically circular plate 98 is mounted on the bolt 114 and is slid until it meets the door frame 96. The diameter of the plate 98 is large enough to extend beyond the door.

A strong nut 118 with a thorough hole in it is threaded on the bolt 114 until it is stopped by the plate 98 and is tightened to it by hand. A padlock (not shown) is inserted through the hole in the nut and the nearest available hole 100 in the bolt, and is locked, preventing the nut from rotation. The door is locked as it cannot swing open in direction 92 due to the collision between plate 98 and the door frame. Plate 98 is preferable upholstered to prevent scratching the door frame.

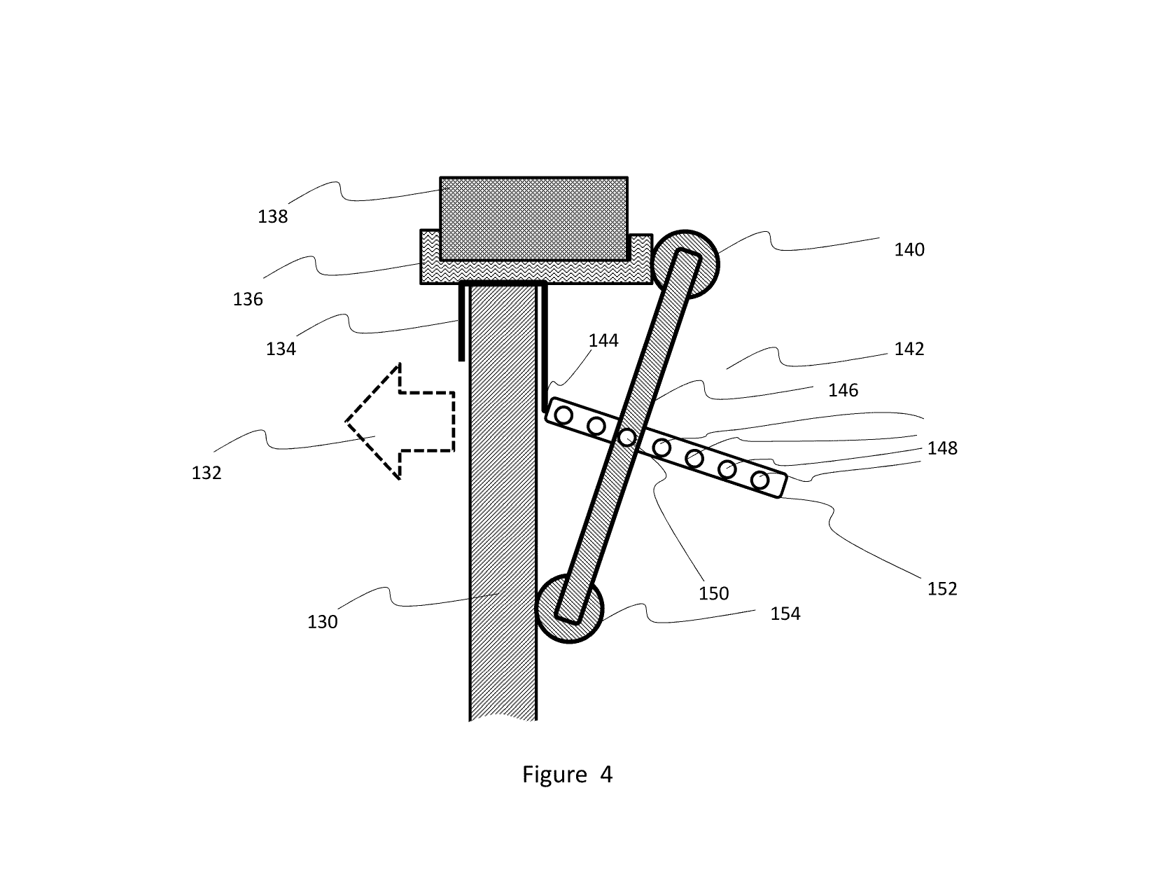

Attention is called to FIG. 4, showing another preferred embodiment of the present invention in a top view of a cross section through the door and the door frame.

A door 130 is partially shown. Its hinges are below the bottom of the illustration. A member 134 made of thin and strong material, such as a 1 mm steel sheet, is bent around the door, having an internal part that grips the door outwards, an intermediate part passing between the door and the door-frame, and an external part connected to a bar 152 perforated with a dense series of holes 148. The connection between bar 152 and clamp 134 has a joint 144 allowing the bar to rotate. Another bar 146 that can be a ½ metal pipe leans on the door where one end 154 leans on the door itself and the other end 140 leans on the on the door frame. The bar 152 passes through a passage in the bar 146 and is pulled strongly away from the door to a position where a hole in bar 146 is aligned with a hole in bar 152, while pulled away from the door. At this position, a padlock is inserted through a hole 150 that is common to bar 146 and bar 152. This locks the door as it cannot swing into the room. The sections 140 and 154 of the bar 146, that come into contact with the surfaces door 130 or the door frame 136, are padded so as to avoid damage to these surfaces.

In another preferred embodiment that is similar to the one in FIG. 4, a metal chain replaces bar 152 and the links of the chain replace the holes 100. The first link of the chain is attached to clamp 134 at point 144, the chain is pulled and wrapped around bar 146, and a padlock is inserted through a link of the chain and around bar 146 to secure the chain and ensure that it remains tense.

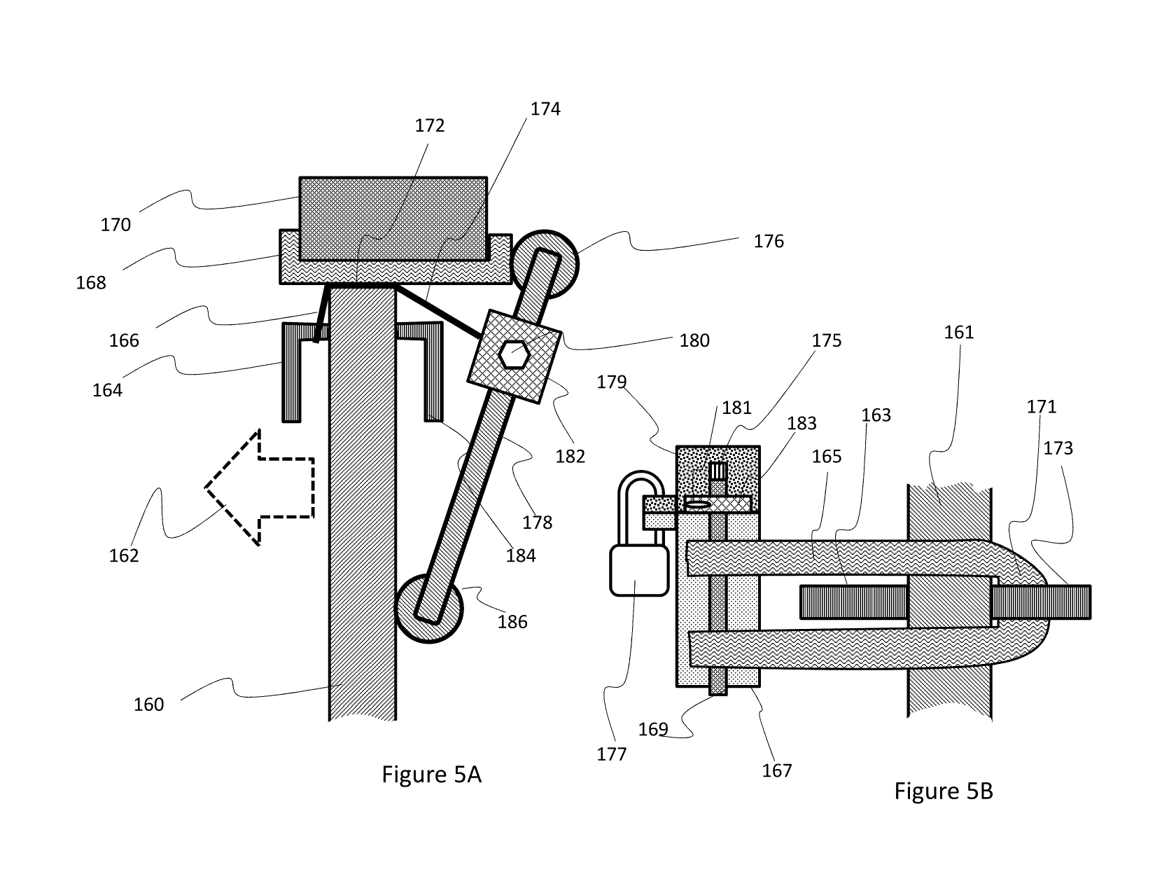

Attention is called to FIG. 5, showing a top down view of a cross section through a part of a door 160, a door frame 168 and a wall 170.

The door swings open into the room, in the direction 162. It has an internal handle 164 and an external door handle 184.

A flexible fabric strap 166 such as typically used for lifting window blinds is wrapped around the internal handle 164 of the door, then passes between the door 160 and the door frame 168, and is then wrapped around an axis 180 of a compartment 182 that can slide along a bar 178. The bar is supported in one end 186 on the door, and in the other end 176 on the door frame 168 or on the wall 170. Axis 180 can be turned in a direction that pulls the wrapped strap 166. A ratchet mechanism, such as found in ratchet wrenches, prevents the axis 180 from turning backwards. The tip of the axis extends out of compartment 182 and is shaped as a hexagon, so that it can be turned with a wrench.

To lock the door, a user turns axis 182 with a wrench and stretches the strap 166 strongly. As the strap is stretched, it pulls the internal handle 164 strongly in a direction that keeps the door closed. A cover (not shown) over the exposed part of axis 182 can prevent access to the axis, and a padlock securing the cover to the compartment 180 (not shown) can prevent removal of the cover, thus prevents access to the axis, thus prevents unlocking the door.

To unlock the door, the user unlocks the padlock, then removes the cover, then turns a ratchet control switch (not shown) which is a part of every ratchet mechanism into the “free” mode, enabling the axis 182 to turn in the opposite direction, releasing the strap.

FIG. 5A shows one embodiment of a strap around a door handle. This is a side view looking at the front of the door 161 from the direction opposite to the hinges. The internal handle 173 and the external handle 163 are shown where a strap 171 is wrapped around the internal handle and passes in front of and around the door. Both ends of the strap are then wrapped around axis 169 in compartment 167. The axis 169 extends out of the compartment so it can be turned by an external wrench engaged with its hexagonal tip 175. A cover 179 can be placed over the tip 175 to prevent access to the tip. A padlock 177 can lock the cover to the compartment to prevent removal of the cover 167. A ratchet mechanism 183 in the compartment has two states—a stretch state, where the axis can rotate in a direction that stretches the strap, and a release state where the axis can rotate in a direction that releases the strap. A switch 181 (that is also covered by cover 179) can change the state of the ratchet.

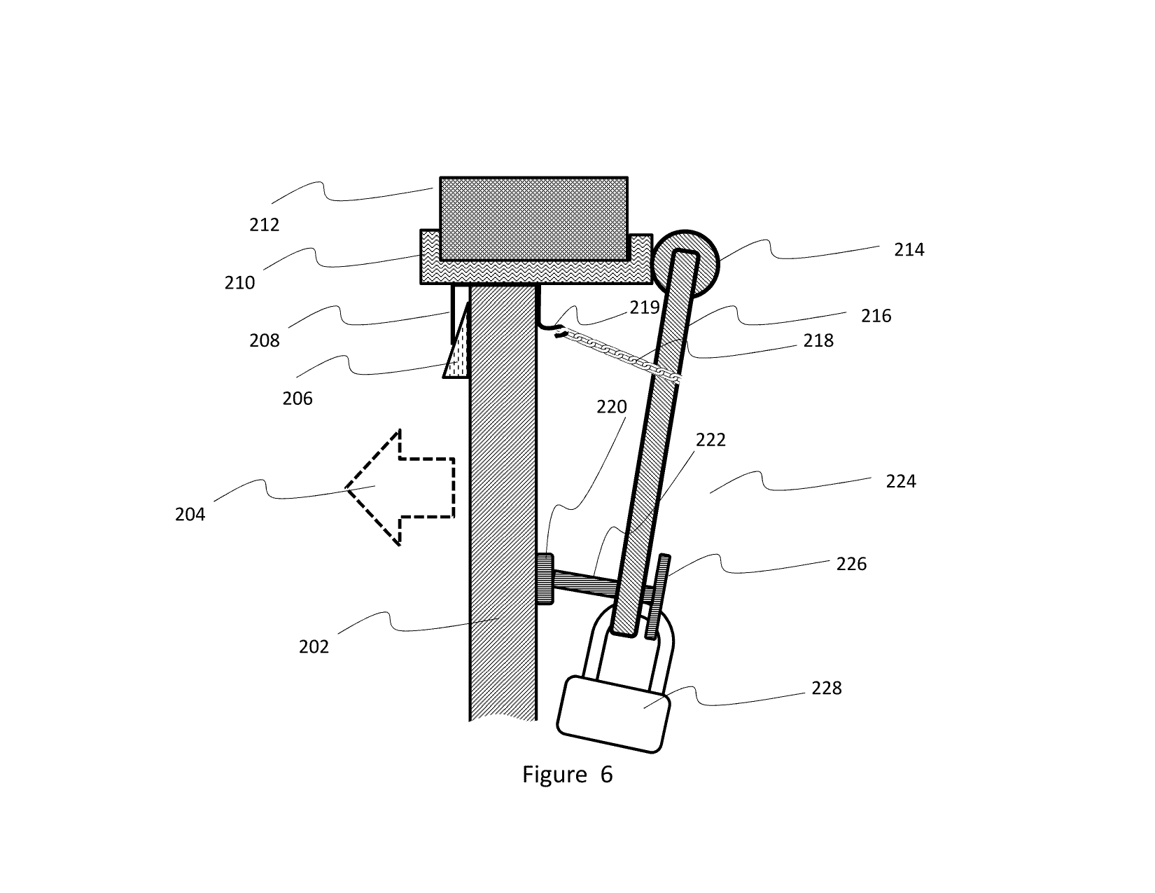

Attention is called to FIG. 6, showing a top down view of a cross section through a part of a door 202, a door frame 210 and a wall 212.

The door swings open into the room, in the direction 204. A clamp 208 made of a strong and thin sheet of steel is placed around the front side of the door, passing between the door and the door frame.

A wedge 206, such as a door stopping wedge made of rubber, plastic or wood is inserted between the clamp and the inside of the door, in order to match the width of the clamp with the width of the door, that may be thinner than the clamp. A piece of chain 218, with relatively small links is hooked on the clamp by a hook 219 which is a part of the clamp. The chain can be hooked using any of its links, and the user pulls the chain to use a link that will make the chain short and tense. The chain is wrapped around a bar 216 that leans in one end 214 over the door frame 210 or the wall 212, and on the other end has a tightening mechanism such as found in G clamps common in workshops, comprising a swivel foot 220, a force screw 222 and a rotating handle 226. When the tightening mechanism is rotated to be extended, it pushes bar 216 away from the door, pulling the chain and stretching it strongly. When the chain is stressed tight, the tightening mechanism is locked with a padlock so that it cannot be rotated and released. The door is then locked. The foot swivel is preferably upholstered to protect the surface of the door.

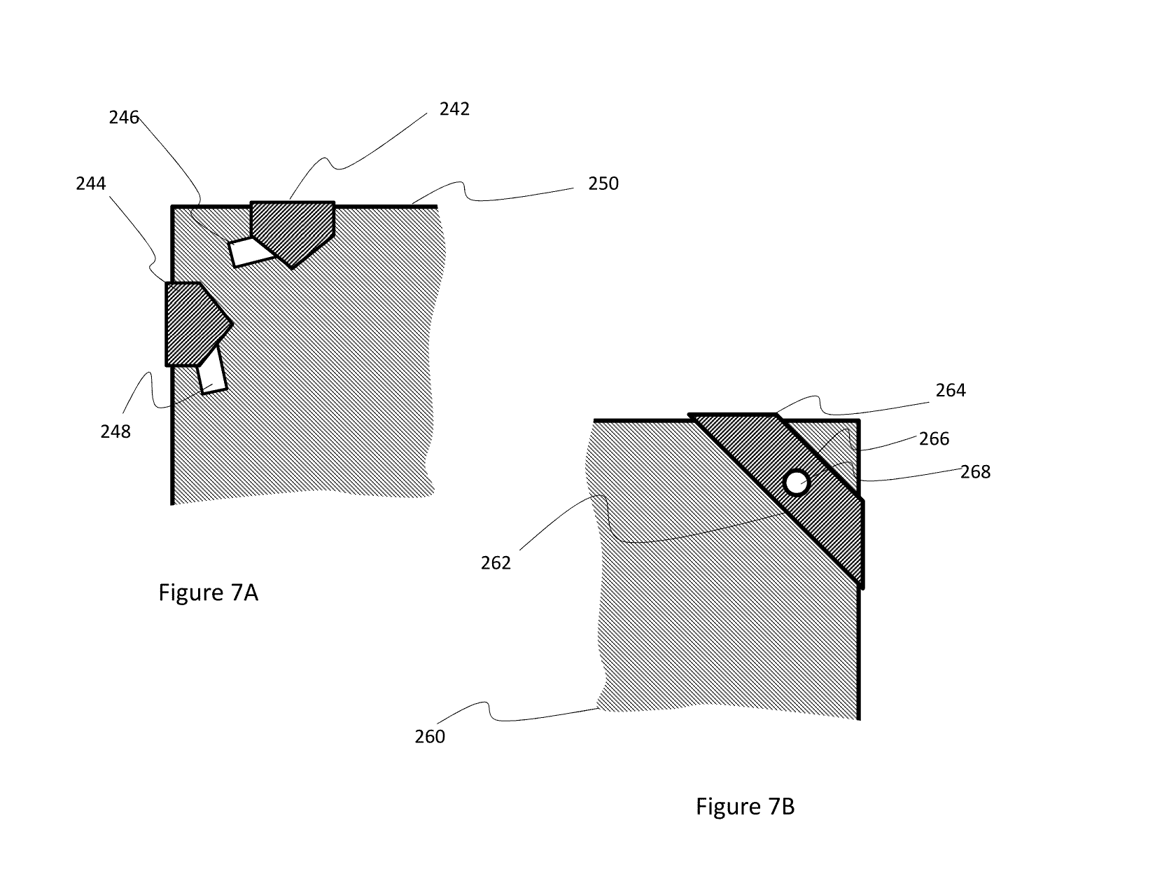

Attention is called to FIGS. 7A and 7B showing a corner clamp to be used in embodiments that need a clamp around the door, such as those described in FIGS. 2, 3, 4 and 6 above. Clamp 242 made of thin and strong sheet of metal or plastic goes around two edges of a door 250—typically the top and the front edges, but also possibley the bottom and the front edges. If the system is to accommodate doors of different thicknesses, the clamp can be made wider than the widest possible door, and wedges 246 and 248—such as door stopping wedges—can be pushed in from the inside of the room, to tighten the clamp to the door.

The clamp 264 goes diagonally on the external side of the door 260, and is fixed to the door at both its ends—to protect it from bending outwards under the stress of the external part of the lock mechanism. The edges 262 and 266 of the clamp may be bent outwards to strengthen their resistance to bending. The corner clamp also provides better stability as it can be placed on the door stably while the user is inserting the wedges.

A hook 268 on the external side of the clamp is used to hook the clamp to the external part of the locking mechanism.

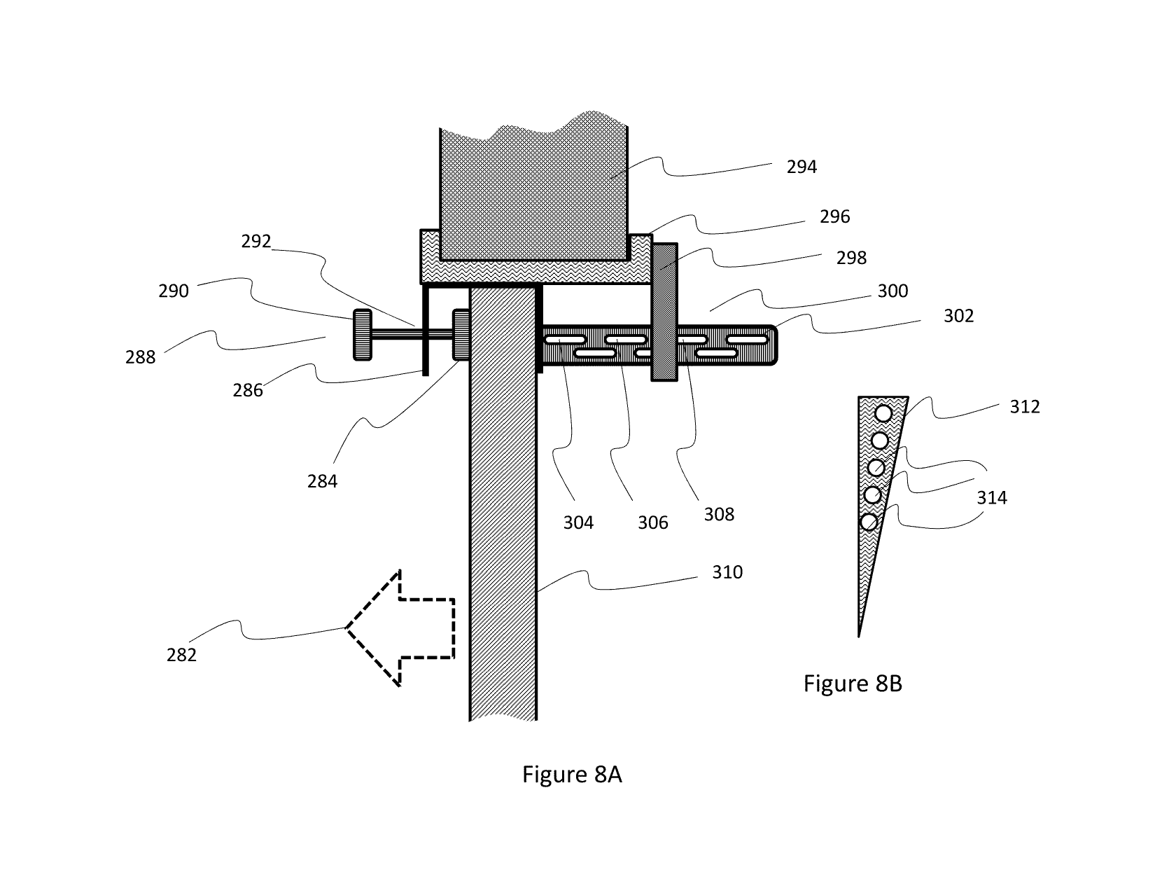

Attention is now called to FIG. 8A, showing a top down view of a cross section through a part of a door 310, a door frame 296 and a wall 294.

The door swings open into the room, in the direction 282.

A G clamp 286 made of thin metal such as a 1 mm steel plate is clamped to a door 310. The hinges of the door are not shown as the door extends down to the hinges beyond the margin of the illustration.

The clamp is clamped to the door with a mechanism 288, comprising a bolt 292 screwed through a threaded nut on the clamp (not shown), an upholstered foot 284 leaning on the internal side of the door, and a knob 290 used to thread the bolt 292 to tighten foot 284 to the door. The clamp passes between the door 310 and the door frame 296 that is fixed to the wall 294.

A solid bar 308 with a preferably square cross section extends perpendicularly from the G clamp to the external side of the door. A bar 298 having a square passage (not shown) that is very slightly larger than the cross section of bar 308 slides along bar 308. Due to the dimensions of the passage in bar 298 and bar 308, bar 298 is always perpendicular to bar 308 and is parallel to the door plane. Bar 298 extends beyond the edge of the door and onto the area of the door frame. As the cross section of the bar 308 is square, bar 298 can be mounted on it in any of the 4 main directions, so it can be used against the top and the side door frame, when the door is left handled or right handled.

A set of interleaved passages 304, 306, 302 etc in bar 308 are used to tighten bar 298 to the door frame when locking the door.

FIG. 8B shows a wedge 312 made of metal or plastic, that can slide into any of the passages in bar 308. The user seeks a slot that is partially extending under bar 298, and pushes the wedge into that passage. The wedge strongly tightens bar 298 against the door frame. Part of the wedge is extending to the other side of bar 308. There is a series of holes 314 in the wedge, and the user selects the highest hole that has fully passed out of bar 308, and inserts a padlock through it (not shown). The locked padlock prevents removal of the wedge, thus prevents release of bar 298, thus keeping the door locked.

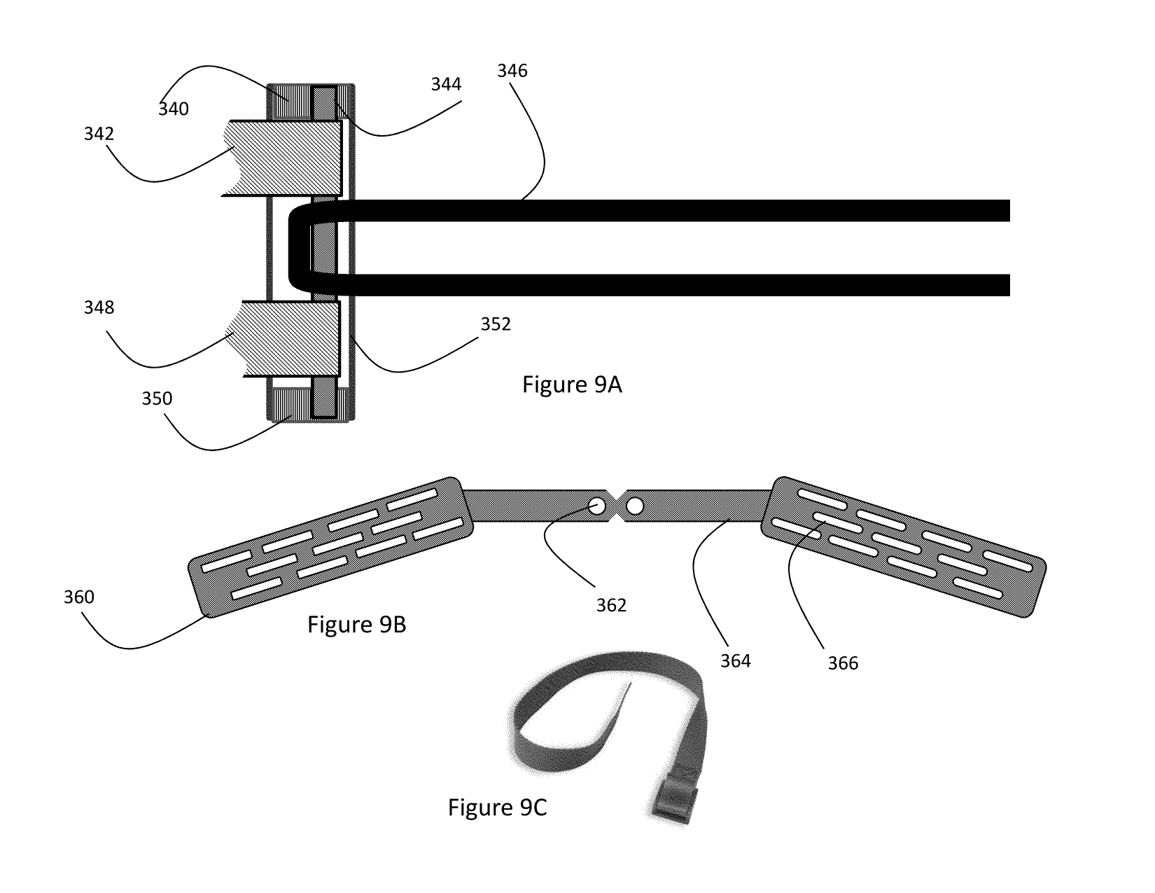

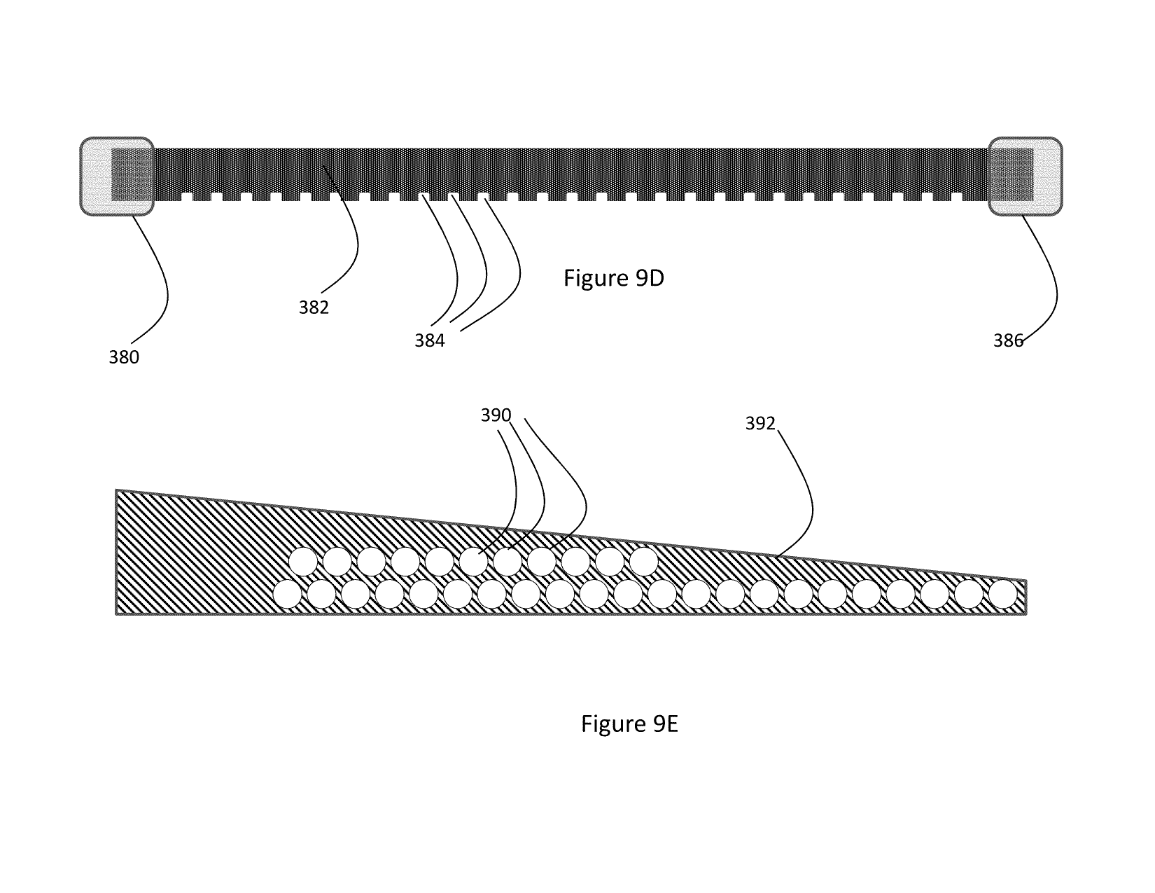

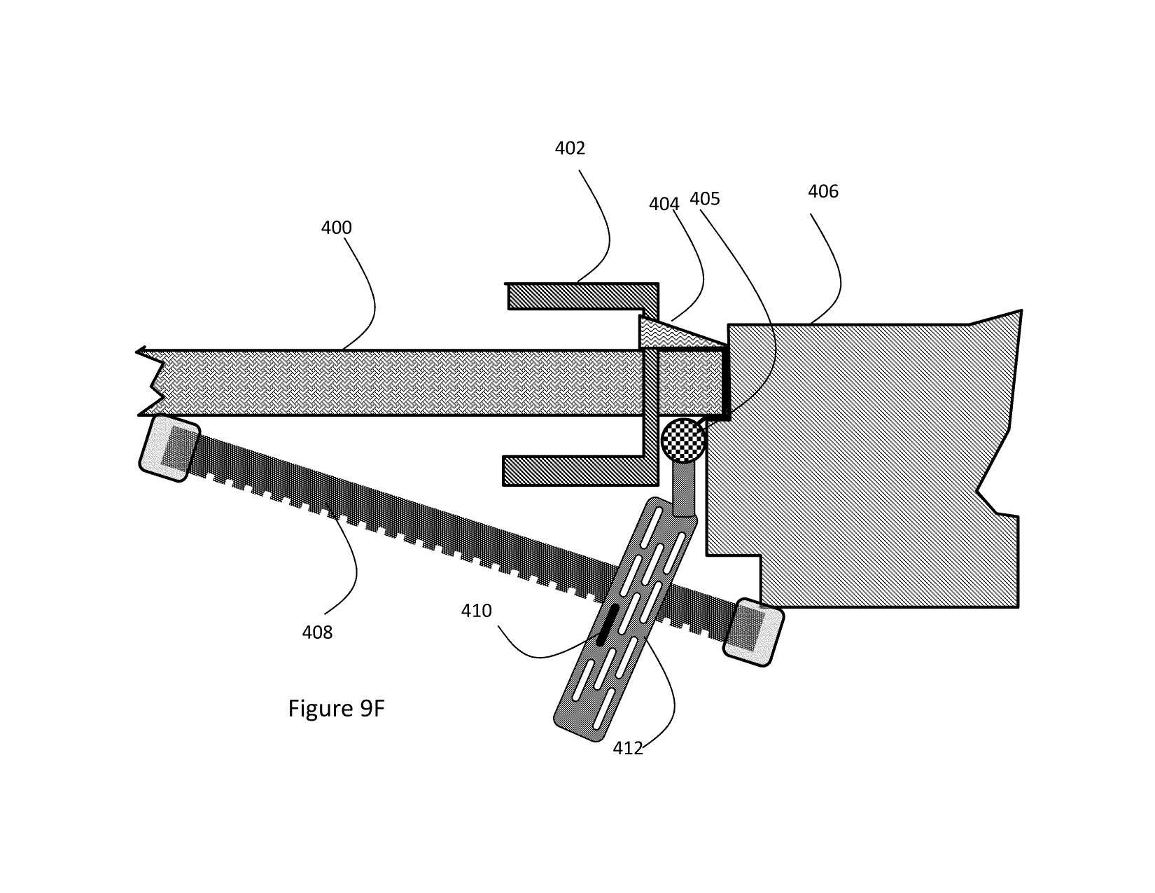

Attention is now called to FIGS. 9A-9F showing another preferred embodiment.

FIGS. 9A-9E show components of this embodiment, and FIG. 9F show how they are assembled to a functional lock according to this invention.

FIG. 9A shows a vertical cylindrical cup 352 with a vertical axis 344 supported by a bottom cap 350 and a top cap 340. Two straps 342 and 348 are wrapped around axis 344 pulling it to one side, while a folded solid ruler 346 wraps around it pulling it to the opposite side.

FIG. 9B shows a spread ruler 364 made of a symmetrical flat metal plate having a wide part 360 with elongated and interleaved holes 366 and a hole 362 to go around axis 344. When the ruler 364 is folded around it axis of symmetry, the hole 362 and the elongated holes 366 overlap with their symmetrical holes.

FIG. 9C show a flexible strap with a buckle.

FIG. 9D show a metal bar 382 with two soft ends made of rubber or plastic 380 and 386, and a set of dents 384.

FIG. 9E show a wedge 392 made of a flat metal plate, with a set of dense round holes each of which can accommodate an ordinary padlock.

FIG. 9F is a top view of an assembled lock, showing a part of a door 400 and a door frame 406. The cup 405 described in FIG. 9A is located tangent and tight to the door 400 and the door frame 406. The strap 404 is wrapped around the axis of cup 405 and around the internal door handle 402. The strap is pulled tight from the inside before the user leaves the room, and then the cup is positioned in place from the outside in its place.

Ruler 412 that is described in FIG. 9B is extending out of the cup 405. Bar 408 is placed between the two parts of folded ruler 412. One end of the bar leans against the door, and the other end of the bar leans on the door frame. The ruler 412 is pulled hard by the user and then the wedge 410 that is described in FIG. 9E is inserted from the bottom side of the ruler upwards, using a selected elongated hole in the ruler. As the wedge is pushed upwards, it increases the pressure on bar 408 towards the door. The wedge is placed in one of the dents of the bar—preventing the bar from moving right or left. When the wedge is pushed upwards, a padlock (not shown) is inserted through the lowest available hole in the wedge, above the ruler. When the lock is locked, the wedge cannot slide down, so the bar cannot be moved, so the door cannot be opened.

We claim:

1. A system for externally locking an inwards opening door, the system comprising:
a. a first member removably and non-invasively attachable to the internal side of an inward swinging door;
b. a removable and non-invasive second member, connectable to the first member, configured to reversibly attach the first member to a fixed object that does not swing with the door; and
c. a lock that, when locked, prevents separation between said two members.

2. The system as in claim 1, wherein the first member is a clamp.

3. The system as in claim 2, wherein the clamp is held to a door with a bolt.

4. The system as in claim 2, wherein the clamp is held to a door with a wedge.

5. The system as in claim 1, wherein the second member leans on the door and on the door frame.

6. The system as in claim 1, wherein the second member is compressed to a floor or carpet and prevents the door from swinging by static friction between said second member and said floor or carpet.

7. The system as in claim 1, wherein the first member is flexible strap.

8. The system as in claim 7, wherein the second member is tightened to the first member by a wedge.

9. A method for locking an inward swinging room door from the outside of the room, the method comprising the steps of:
a. mounting a first member on the door before it is closed;
b. closing the door;
c. connecting a second member to mechanically link the first member to a stationary object; and
d. applying a lock to prevent disconnecting the second member from the stationary object.

10. A method of locking an electronically lockable door without using electricity, the method comprising the steps of:
a. neutralizing the electronic lock; and
b. mounting a mechanical lock as described in claim 1.

11. The method of claim 10, wherein the neutralizing is done by blocking the face plate mouth of the door.

12. The method of claim 11, wherein the blocking is done with a magnetic plate.
